(19) United States
(12) Patent Application Publication
(10) Pub. No.: US 2008/0247809 A1
(43) Pub. Date: Oct. 9, 2008

(54) Assembly With Applicator Device For Applying A Liquid Such As Scent On A Wetable Surface Such As Human Skin

(76) Inventors: Richard Rene Bloc, Derchigny-Graincourt (FR); Yves Ducroquet, Chaudon (FR)

Correspondence Address: ST. ONGE STEWARD JOHNSTON & REENS, LLC, 986 BEDFORD STREET, STAMFORD, CT, 06905-5619, US

(21) Appl. No.: 12/140,739

(22) Filed: Jun. 17, 2008

Related U.S. Application Data
(63) Continuation-in-part of application No. 12/042,133, filed on Mar. 4, 2008.
Application No. 12/042,133 is a continuation-in-part of application No. 11/295,047, filed on Dec. 6, 2005, now Pat. No. 7,338,228.
Application No. 11/295,047 is a continuation of application No. PCT/FR04/01402, filed on Jun. 7, 2004.

(30) Foreign Application Priority Data
Jun. 6, 2003 (FR) 0306897

(51) Int. Cl. B05C 11/02; B05C 11/00

(52) U.S. Cl. 401/266; 401/262

(57) ABSTRACT

An application device for a liquid product, contained in a reservoir bottle having a lid for closing the opening of the bottle, through which at least one capillary migration channel for the liquid product passes towards a wetable surface on contact therewith is provided. Several similar capillary channels are preferably provided, which can alternatively function as openings for the entry of air through the lid. One of the ends of each channel opens outside the lid. The other end opens in a collector tube for the liquid product, contained in the bottle. The collector tube is embodied to hold a fixed amount of liquid product against gravity by capillary action, until the above is drawn off by capillary migration through the lid channels.

### CROSS-REFERENCE TO RELATED APPLICATIONS

This application is a continuation-in-part of U.S. application Ser. No. 12/042,133, filed on Mar. 4, 2008, currently pending, which is a continuation-in-part of U.S. application Ser. No. 11/295,047, filed on Dec. 6, 2005, now U.S. Pat. No. 7,338,228 issued on Mar. 4, 2008, which is a continuation of International Patent Application No. PCT/FR2004/001402, filed on Jun. 7, 2004, which designates the United States and claims priority of French Patent Application No. 0306897 filed on Jun. 6, 2003.

### FIELD OF THE INVENTION

The present invention relates to an applicator device used to control the distribution of a liquid product from a reservoir bottle and ensure spreading it regularly onto a support surface. It finds a preferred although non limiting application in the packaging of high-cost liquids in small volumes, as is done in particular in the perfumery or pharmaceutical industries.

### BACKGROUND OF THE INVENTION

The chemical, pharmaceutical and cosmetic industries market numerous liquid products which are packaged in various small bottles equipped with means for delivering the liquid product to the outside in a regulated way, in a single shot or in several shots spaced over time.

A particularly common place example of such various small bottles is that of bottles containing ophthalmic solutions. These bottles are equipped with dispensing adaptors in which a capillary duct constitutes a nozzle delivering the liquid one drop at a time. The expulsion of each drop is encouraged either under the effect of gravity, when the bottle is placed head down, or by the effect of a raised pressure exerted by hand by compressing the walls of the liquid reservoir. Patent Application EP 0 436 264 describes an adaptor of this type, in an application to a vaccine. Therein it is explained how the end diameter of the capillary duct is determined to ensure that a drop of the desired volume is formed. The bottle is tilted upside down so as to let the drop fall down, such as in eye-drops.

The present invention aims at designing an applicator device that is able to regulate a diffusion of liquid far more slowly than is achieved in dropping dispensers. Devices that can distribute the liquid slowly and deposit a thin layer of the liquid onto a flat surface are known in the field of writing instruments. In such case again, the reservoir pen is used for writing with the hand from upward on a sheet of paper that is put on a table and the dispensing head with the dispensing head tip is brought downwards. Further, the ink is generally dispensed direct from a reservoir in the form of a long tube that contains all the available ink. It is important that the user can write a long time without the ink feeding been interrupted. Writing implements of such type are disclosed in particular in U.S. Pat. No. 7,004,660, U.S. Pat. No. 6,454,842, U.S. Pat. No. 5,238,320, and U.S. Pat. No. 6,572,297.

The purpose is different for the device of the present invention, which is adapted to distribute as a regular stream just a dose of liquid that is withdrawn from a reservoir bottle of much wider volume. Such is a problem that has to be solved especially in the perfume industry or in similar applications in the pharmaceutical industry, when a liquid drug should be locally applied on human skin to spread thereon and be absorbed. The art illustrated in French patent application published under number 2,720,608 cannot, however, be held up against the present invention. In that prior patent application, the device described is a portable device for diffusing scent which comprises, at the end of a capillary neck, a porous silica pellet the purpose of which is to allow the scent to escape to the open air not in the liquid state, but in the vapor state.

By contrast, the applicator device of the invention is designed to allow the liquid product, such as scent, to be distributed selectively when the applicator device is in contact with an appropriate wetable surface, through the effect of capillary migration of the product in the liquid state. Devices for dispensing perfumes are also disclosed in U.S. Pat. No. 2,579,202 or U.S. Pat. No. 4,225,255, which however do not comply with the need that the liquid does not vaporize and escape from the reservoir bottle when not in use.

### SUMMARY OF THE INVENTION

An object of the invention is to solve the problems encountered when the liquid to be dispensed from a reservoir bottle is an easily vaporizing liquid such as perfumes.

A further object of the invention is to provide an assembly comprising a reservoir bottle, a dispensing head formed with migration canals or holes at an outside end of an insert part fitting in a neck of said bottle, and a cap for covering said dispensing head when the assembly is not in use, that is especially convenient for liquids such as scents, perfumes, or similar liquids that need be applied on the skin optionally handling the bottle upright.

Another object of the invention relates to not spending more liquid than is strictly desired at a time, which is important for instance when the liquid is an expensive product or when it contains a drug compound that should not be spread out but on a specific place on the skin of a human body.

According to still a further object of the invention, there are provided means that ensure that any liquid remaining on the outer surface of the applicator device after a liquid distribution be retained inside the cap used to cover the applicator device and though not be permitted to go back into the bottle through the migration canals.

All these objects are met by the invention as defined in the claims.

It will be understood that, according to the invention, use is made of the capillary phenomena in two different ways in the operation of one and the same device. Upstream, toward the reservoir bottle, the applicator device comprises a withdrawing tube which is advantageously in the form of a capillary duct such, particularly in terms of its diameter and its length, that it is capable, depending on the surface tension of the liquid with respect to its interior surface, of holding a determined dose of liquid without this dose dropping back into the reservoir, irrespective of the position of the assembly with respect to the direction of gravity. Downstream, toward the outside, the device comprises one or several capillary migration canals which advantageously consist of a few capillary holes through its lid and which are themselves so fine that they allow the liquid to pass only when a wetable material is brought into contact with the lid, thanks to a suction effect that is strong enough to overcome the capillary retaining forces which, in these capillary canals, oppose the flow of the liquid.

The withdrawing tube and the capillary migration canals differ through their respective construction, through their relative arrangement, and through their functions. Mainly, while the withdrawing tube shows a cross-sectional area markedly smaller than that of the bottle, the migration canals have in turn a cross-sectional area much smaller than that of the withdrawing tube. Typically, the migration canals are holes pierced at the end of the withdrawing tube through a flat radial end wall of a lid formed by an outer head part of the applicator device, and said holes have a diameter from 0.3 to 0.6 mm. They are preferably at least three in number, in positions at regular angular intervals around the central axis of the device. In connection with the section area and number of those holes, the inside diameter of the withdrawing tube is typically from 3 to 6 mm. In preferred embodiments according to the invention, the withdrawing tube is provided with fins that extend axially along it and protrude in direction of the central axis, thereby reducing the width of all passageways for the liquid between the fins and enhancing the capillary effect useful for retaining the liquid withdrawn in the tube. The length of the tube depends upon the volume of liquid desired for each single dose.

In the preferred embodiments of the device of the invention, a particularly simple method of construction is anticipated by producing the withdrawing tube and the capillary canals in a single piece, advantageously obtained by molding from a polymer material, which sealingly plugs the reservoir bottle when forced into a neck thereof. Since the constituent material is then the same for the withdrawing tube and the migration canals, the difference in capillary effect and operation is due essentially to their respective diameter or cross section area offered as a passageway to the liquid. Another advantageous difference between them is in regard to their length. The capillary canals are preferably relatively short, the lid in particular being relatively thin for this purpose. This eases the effect of migration when the liquid is attracted by the wetable surface brought into contact with the lid. The withdrawing tube for its part is long enough to accommodate the volume of a dose of liquid, namely of a drop.

In its preferred applications, the applicator device according to the invention is used to plug a reservoir containing a sample of scent. Scents and other eaux de toilette represent flagrant examples of expensive products that have not to be wasted, although in addition, in order to be effective, they need only be used in very small quantities. Furthermore, it has become customary to make small-capacity samples, corresponding to a few drops of scent, available to consumers so that they can test the scents given off under normal conditions of use when the scent is applied to their skin. Between two applications of such a scent, for example when the bottle is reinverted just after an application, the withdrawing tube fills with a drop of liquid which remains captured therein through a capillary effect, and it is only when the lid of the device is applied to the skin that the scent passes through the capillary migration canals to be deposited on the user's skin.

According to a secondary characteristic recommended by the invention, there are provided a plurality of capillary canals through the outer lid of the applicator device, so that one can act to let the liquid migrate from the withdrawing tube to the wetable surface the lid is contacted with while another allows air to enter the bottle to replace the liquid consumed. The number of capillary canals is in particular five, with one located on the center axis and the other four placed on an annular ring around the axis at right-angle intervals. And each is able to act to release the liquid product by capillary migration from the withdrawing tube or as an air intake toward the reservoir of the bottle, either at the same time or, more generally, when the application in contact with the wetable surface has finished.

### BRIEF DESCRIPTION OF THE DRAWINGS

The invention will now be described more fully in the context of preferred characteristics and of their advantages, with reference to FIGS. 1 to 12, in which:

FIG. 1 is a view in section partially depicting a bottle forming a reservoir for a liquid product, at the point where this bottle is equipped with an applicator device according to a first embodiment of the invention, covered by a cap;

FIG. 2 illustrates the applicator device of FIG. 1 in a view from above;

FIG. 3 depicts, in a view in section, a perfume applicating assembly including the bottle and the applicator device with its cap, considering the bottle in a vertical position, when the liquid it contains is concentrated in the bottom and the withdrawing tube is empty;

FIG. 4 is a view in section showing the assembly once it has been inverted in a downward position, the cap having been removed;

FIG. 5 is a view in section of the assembly, in a situation in which this bottle is in an upright vertical position and in which the withdrawing tube is full of liquid held by capillary effect inside the withdrawing tube;

FIG. 6 shows in axial section a preferred embodiment for the applicator device of the invention, with its associated cap fitted on the outer part of the insert closing the bottle;

FIG. 7 shows the applicator device of FIG. 6 as viewed upwards from inside the bottle;

FIG. 8 is an outside view of the insert and lid part of the applicator of FIG. 6 with the cap having been removed;

FIGS. 9 and 10 on the one side and FIGS. 11 and 12 on another side represent the complete assembly of the invention when equipped with the applicator device and cap according to the preferred embodiment of the invention, with the construction of the reservoir bottle being different depending on whether it is made of glass or of a polymer material such as polyethylene or polypropylene.

### DETAILED DESCRIPTION OF THE INVENTION

In the context of the embodiments chosen here, the invention is employed on a pocket-sized bottle containing from the outset a sample of scent. However, it will be understood that the embodiments of the device according to the invention are restricted neither to the dimensions that will be given hereinafter nor to the shapes illustrated as preferences in the figures, nor to the materials, and the invention extends to cover any variant embodiment that remains within the scope of the protection afforded by the attached claims.

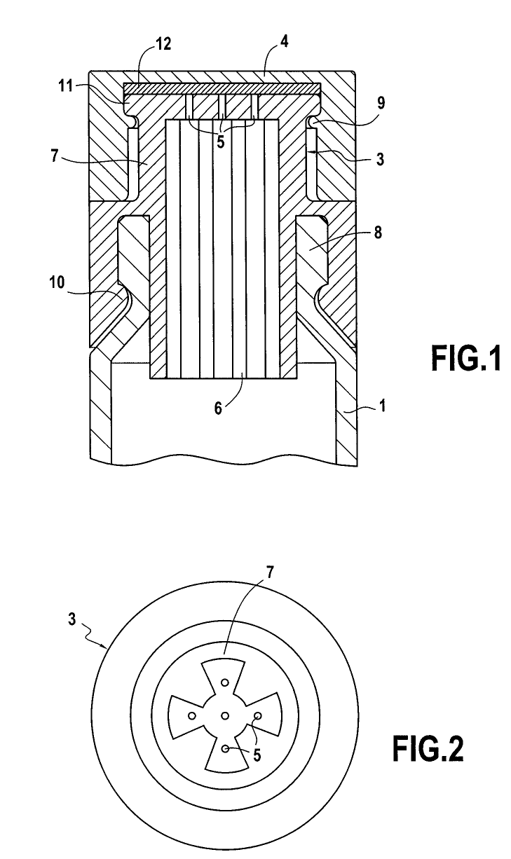

The embodiment of FIGS. 1 to 5 will first be described.

The applicator device 3 according to the invention is produced in the form of an adaptor which is mounted through the neck of a tube that constitutes a bottle 1, intended to contain a liquid product such as scent, illustrated as 2. This applicator device includes an inner part and an outer part that are integral together. The inner part, or insert part, indeed the withdrawing tube 6 in the case of FIG. 1, penetrates axially inside the bottle. The outer part, or head part, forms a lid 7 that extends out of the bottle neck and covers the opening of the bottle.

The bottle 1 is made of a glass tube or a similar tube in a polymer material. The dimensions of the tube in length and inside diameter are several or many times more than the length and inside diameter of the withdrawing tube penetrating therein, so that the available container volume is enough to contain much more liquid than the dose received in the withdrawing tube each time the device is used. As apparent from FIG. 1, the bottle tube comprises a collar 8, formed as a protrusion beyond the exterior periphery of its neck around is opening. It is designed to allow the attachment of the adaptor or applicator device to the bottle. The latter is in the form of a solid cylinder, stepped down to a hollow cylinder the interior wall of which is of a shape that complements that of the collar 8. Between the hollow cylinder and an extension of the top solid cylinder, an annular space is formed in which the neck of the bottle fits. The lid 7 is held on the neck of the bottle 1 by the peripheral edge of the lid 7 at the base of the internal wall of the hollow cylinder part of the lid 7, which has an attachment bead 10 that fits into a complementary groove belonging to the bottle.

As shown by FIGS. 1 and 2, the upper flat wall forming the top face of the lid 7 which closes the opening of bottle 6 is pierced with a plurality of holes 5 that constitute capillary canals for the liquid migrating outside the assembly. There are five such canals, in a regular distribution pattern, with one being on the central axis of the device and the other four around at right angle intervals on an annular ring. These canals are open at their longitudinally opposed two ends. Toward the top in FIG. 1 they open to the outside of the device whereas toward the bottom they open into a cylinder part of the applicator device, which forms a withdrawing tube 6 for the scent 2 and penetrates as an insert in the top part of the bottle forming its open neck.

The lid 7 and the withdrawing tube 6 are made as a single piece, advantageously out of a polyolefin-based polymer material. Polyethylene is generally preferred, although polypropylene may also be used. Manufacture can be done easily by injection-molding. The canals 5 may be produced by piercing the material once it has hardened. The material thus chosen has the advantage of being resistant to chemical attack. Further it is more readily wetted by the scent solutions than the material of the bottle 1 when the latter is made of glass, as is generally the case. However, since glass has the drawback of breaking easily, bottle 1 can also be made of a similar polymer material as the applicator device including the insert part 6 and the lid part 7. In preferred embodiments as described herein, the bottle is made as a simple tube that shows externally an outside diameter that is of the same order of magnitude as the diameter of the applicator device.

The withdrawing tube 6 has an inside diameter markedly smaller than the inside diameter of the bottle 1 so as to receive only a dose part of the liquid that the bottle may contain and to act to hold and retain that dose inside it through a capillary effect. In the case of FIG. 1, the outside diameter of tube 6 is determined according to the inside diameter of the neck of the bottle 1 so that the two surfaces are in sealed contact with one another and so that the bottle is thus hermetically sealed at this point. In this way, external air can enter the bottle 1 only through the capillary canals 5. The latter are very fine. They do not allow the liquid to leave through the lid unless the latter is applied on a wetable surface such as skin to force the liquid to migrate through it from the withdrawing tube.

The withdrawing tube 6 is preferably some 10 to 20 millimeters long. A longer way for the liquid to travel to the dispensing holes might be detrimental with respect to the migration effect. However it is conformed in cross section so as to accommodate a convenient dose of liquid and retain it efficiently by capillary effect. As clearly apparent from FIG. 2, the internal chamber 21 inside withdrawing tube 6 is divided in four sectors by fins 22 that protrude inwardly from tube 6 toward an axial space 24 that remains void. Fins 22 extend all along tube 6 up to the radial terminal wall 23 pierced with holes 5. They end on it each in the sector interval between two adjacent fins. Thanks to such arrangement, the internal volume inside the tube is divided into four chambers each in communication with the central axial space. Any flow of liquid through the tube thereby occurs forming five streams in duct spaces that have a reduced width compared to the total diameter of the tube, and the capillary retaining effect is thereby enhanced. The relationship between the distribution of the holes 5 and that of fins 22 ensures that each migration canal opens in a respective flow passageway.

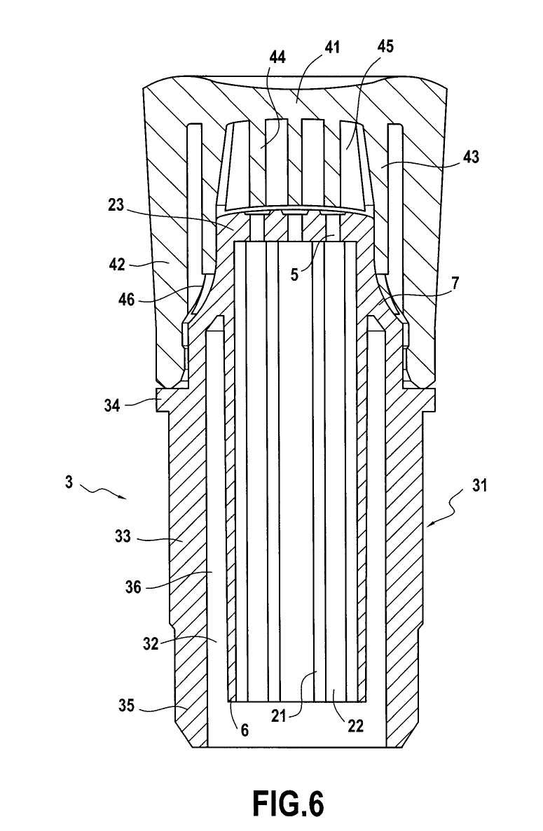

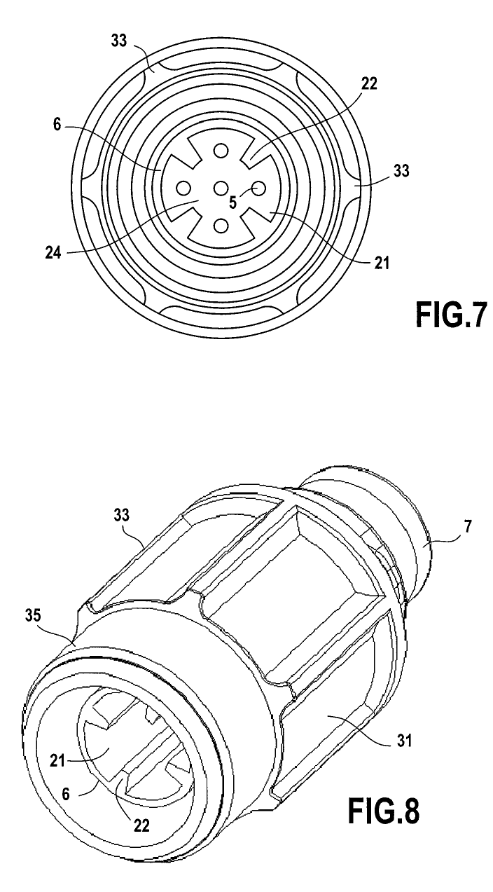

Similar distribution and relationship are afforded in the preferred embodiment of the applicator device according to the invention as shown on FIGS. 6 and 7, with the five holes or migration canals 5 pierced through the terminal flat wall 23 of the applicator lid part 7 and the respective five duct spaces leading to them that are formed by the four fins 22 along withdrawing tube 6.

The withdrawing tube 6 of FIGS. 6 and 7 has typically an inside diameter of 4.5 millimeters and a length of 16 mm, while the capillary canals have a diameter of 0.4 mm and a length of not more than 1 mm (corresponding to the wall thickness of the top face of the end-fitting constituting the applicator device).

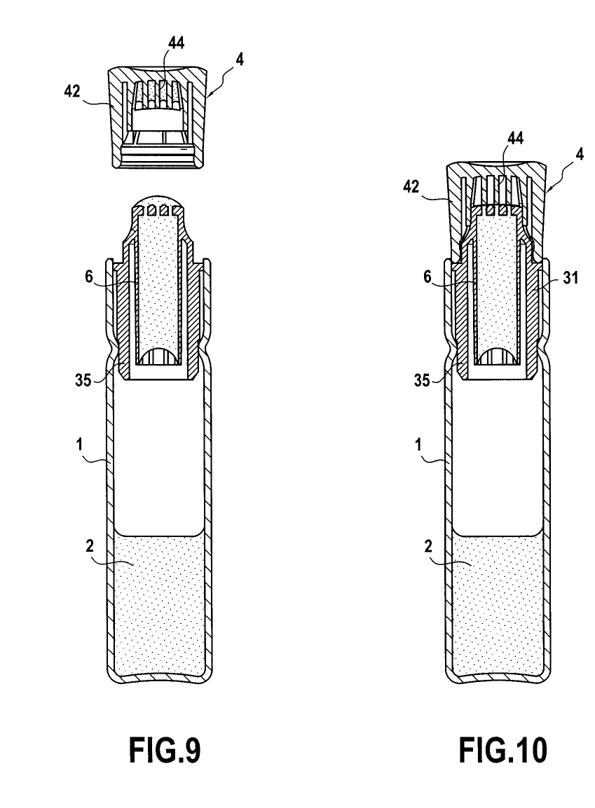

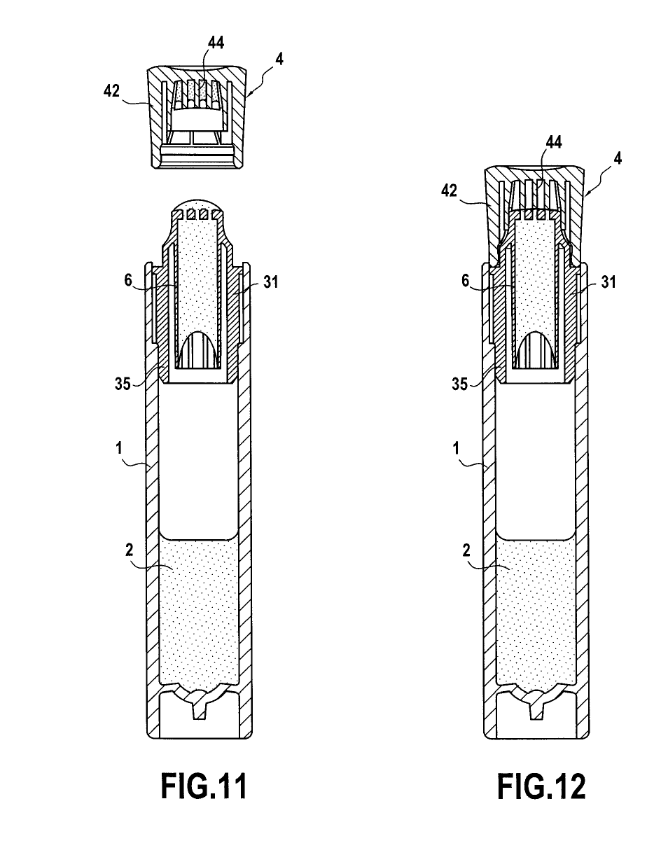

The device according to FIGS. 6 to 8 is different from that of FIGS. 1 an 2 concerning the way the withdrawing tube and closing lid fit in the bottle neck. In the preferred embodiment of the invention the withdrawing tube 6 does not come itself close to the bottle neck. It is provided as a cylinder partition extending from the upper lid part 5 of the applicator device 3 down a lower insert part thereof 31. The insert body forms a sleeve that surrounds the tube at some distance so that an annular space 36 is formed between them. The sleeve is provided with external fins 33 that ensure close fitting of the insert inside the bottle neck by forcing it in. Fins 33 extend from an upper outer flange 34 down to a lower end 35 of reduced section, in an arrangement that ensures correct sealing contact with the bottle at the level of a cooperating form of its neck as shown on FIGS. 9 and 10 or FIGS. 11 and 12. When the insert part is that in position inside the bottle neck with the withdrawing tube penetrating in the bottle, the lid part 7 protrudes outside the bottle.

According to the invention the assembly further comprises a removable cap 4 that is used to cover the applicator device and encloses the lid part 7 thereof when it is not in use. In the preferred embodiment according to FIGS. 6-12 the removable cap is again different from that of the assembly of FIGS. 1-5, both considering its cooperation with the outer skirt of lid part 7 and considering the means it comprises to close the migration canals and retain traces of liquid possibly remaining on the lid terminal wall 23 after use. In both cases however the cap is so conformed that it fits over the lid 7 until it comes in abutment with an external flange of the device, such as flange 34 on FIG. 6, formed at the limit between insert part 31 of device 3 and lid part 7. In both cases also, the cap 4 is designed to be fixed onto the end of the lid 7 rather than onto the bottle 1. To this end, the peripheral wall of the cap on its internal face and the peripheral wall of the lid on its external face have complementary shapes that engage together in a sealing manner when the cap comes in abutment with the above flange that limits its axial displacement with respect to the lid.

As apparent from FIG. 1 for the first embodiment, the cap 4 internally has a shape that complements that of the lid 7, where there is a rim 11 formed projecting from the peripheral surface of the solid cylinder of the lid and a ring 9 formed projecting from the interior wall of the cap. Thus secure closure is ensured, minimizing the ingress of air that occurs when the cap 4 is removed and causes scent to pass too quickly through the capillary canals 5 of the lid 7, thereby causing product to be lost as the cap is removed. It will also be noted from the figures that the cap 4 externally has the same diameter as the outer cylinder of the lid 7 and that this diameter is also substantially the same as that of the tube that forms the bottle 1.

In the preferred embodiment according to FIG. 6 and as can also be apparent from FIGS. 9-12, the cap comprises two concentric cylindrical walls, with an internal skirt 43 that is distinct from the outer skirt 42 of the cap and extends downwards from the radial terminal wall 41 thereof, with the purpose of ensuring a sealing connection with the outer peripheral surface of the lid 7. Further sealing means are provided by lip parts 46 that are supported by attachment links between skirt 43 and sleeve 42 and so constructed that they close any passage between the lid and the cap when the cap is brought in place in abutment on flange 34.

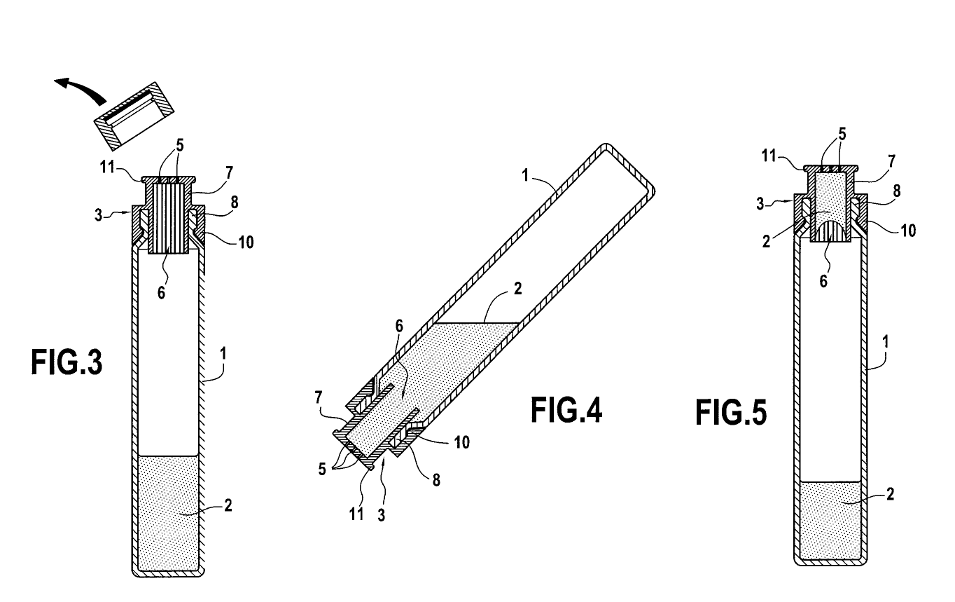

Referring now back to the case of FIGS. 1 and 3, the closing means for the migration canals and the means for retaining any last trace of liquid outside the lid are constructed as a fine layer of absorbent material that covers the internal radial face of the cap and fills the space between it and the terminal wall 23 of lid 7 when the cap is in place over collar 8. The absorbent material is an organic resin foam for example. The purpose of this absorbent pad 12 is to mop the top film of scent that may remain flush with the outside of the lid 7 at the ends of the canals 5 after scent has been applied. Its effect, however, remains superficial, without continuing to suck and use up any scent that may remain available in the tube 6.

In the preferred embodiment as illustrated by FIG. 6, there is no layer of absorbent material, with the advantage that no liquid can migrate through such material and escape as vapor across the sealing means. The closing means for holes 5 are formed by extensions of the cap material that extend from the terminal face 41 down to the end wall 23 of the lid. They are long enough so as to provide empty spaces between them in which any trace of liquid remaining on the lid after use is collected (see FIGS. 9 to 12). More precisely, the extension for the central hole is a central leg while for the other four holes there is provided an annular ring extension that ensure rigidity and correct placement with respect to the holes. Said ring ensures rigidity also for the central extension since the latter is attached to it by radial links.

The operation of the assembly of the invention will now be explained from FIGS. 3-5.

Before the bottle equipped with the applicator device according to the invention is ever used, the withdrawing tube 6 needs to fill with scent, and this is obtained easily when the bottle is inverted, passing through a position like the one illustrated in FIG. 4. The scent remains held in the tube 6 by a capillary effect. The capillary forces are enough to withstand the force of gravity when the bottle is returned to an upright vertical position.

It is not until later when the transverse face 23 of the lid 7 is applied to the human skin that a little scent is deposited there, because the skin is a wetable material. Being more wetable by the scent than is the material of which the applicator device is made, it tends to exert a suction effect which causes the scent to be transferred by capillary migration through the canals 5.

As soon as the applicator device is moved away from the surface of the skin, the attractive effect ceases and the capillary canals resume their role of closing off the tube 6, which keeps the unused remainder of the withdrawn scent. However, by virtue of the presence of at least two capillary canals, air enters the bottle 1 via one of them and reestablishes the pressure therein. This allows the product to be delivered continuously as long as contact with the skin or an equivalent material lasts. The pressure equalizing is also useful in allowing the withdrawing tube to refill from the mass of scent remaining in the bottle.

The foregoing description clearly explains how the invention makes it possible to achieve the objectives it set itself. However, the invention is not limited to that which is specifically described and depicted. In particular, the applicator device according to the invention may be fixed to other bottles containing, for example, cosmetic products such as liquid deodorants or makeup removal fluids. It may also be used on bottles containing products other than products to be applied to the body, for example bottles of adhesive. Furthermore, the same products may be applied to wetable materials that behave in a similar way to that which has been explained in the case of human skin, for example a textile fabric.

What is claimed is:

1. An assembly for dispensing a liquid onto a wetable surface comprising a reservoir bottle for containing said liquid and an applicator device having a lid part adapted to close the opening of said bottle and an integral insert part adapted for sealing connection with a neck of said bottle around said opening, a withdrawal tube formed in said insert part, that penetrates axially into said neck and is constructed so as to retain a determined dose of liquid product withdrawn from said bottle against the action of gravity through a capillary effect, a plurality of holes pierced through a terminal radial wall of said lid part that are constructed as migration canals for the capillary migration of said liquid product to a wetable surface brought into contact with said lid wall outside said bottle, a downstream end of said capillary migration canals opening to the outside of said lid and an upstream end of said migration canals opening in said withdrawal tube, and a removable cap fitting over said lid part of the applicator device for sealing connection with an outer axial surface thereof, said cap further comprising internal means to close said migration canals and means to collect and retain any trace of liquid remaining on the lid surface after the applicator device has been in use, wherein axial fins are formed along said withdrawal tube that protrude inwardly inside said tube, thereby dividing the section area within said tube into different passageways for the liquid with each said passageway leading to a respective one of said migration canals.

2. The assembly of claim 1, wherein said migration canals are five in number, with one being located on the center axis and the other four being on an annular ring around the axis at right-angle intervals.

3. The assembly of claim 1, wherein said holes through said lid wall are able to act to release the liquid product by capillary migration from the withdrawing tube or as an air intake toward the reservoir of the bottle.

4. The assembly of claim 1, wherein said removable cap is covered on the interior surface of its radial terminal wall with a layer of material that is absorbent for the liquid possibly remaining on the outside of said lid after the applicator device has been in use, but unable to absorb the liquid inside the migration canals and the withdrawal tube.

5. The assembly as claimed in claim 1, wherein said closing means for said migration canals are formed by extensions that extend in axial direction from a radial terminal wall of said cap and are long enough to come close to each individual migration canal when said cap is in position to cover said lid part of said applicator device in sealing relationship with a peripheral outer surface thereof.

6. The assembly as claimed in claim 5 wherein said axial extensions are long enough so as to provide empty spaces between them in which any trace of liquid remaining on the lid after use is collected.

7. The assembly as claimed in claim 1, wherein said migration canals are five in number, with one being located on the center axis and the other four being on an annular ring around the axis at right-angle intervals and wherein said closing means for said migration canals are formed by extensions that extend in axial direction from a radial terminal wall of said cap and are long enough to come close to each individual migration canal when said cap is in position to cover said lid part of said applicator device in sealing relationship with a peripheral outer surface thereof and long enough to provide empty spaces between them in which any trace of liquid remaining on the lid surface after use is collected.

8. The assembly as claimed in claim 7, wherein said extensions comprise a central axial extension for the one migration canal that is located on the center axis, while for the other four migration canals there is provided an annular ring extension that ensure rigidity and correct placement with respect to the canals.

9. The assembly as claimed in claim 1 wherein the withdrawal tube is provided in said insert part of said applicator device as a cylinder partition extending from said lid part and the insert body forms a sleeve that surrounds the tube at some distance so that an annular space is formed between them.

10. The assembly as claimed in claim 9, wherein said sleeve is provided with external fins that ensure close fitting of said insert part inside the bottle neck by forcing it in.

11. The assembly as claimed in claim 1, wherein said capillary migration canals have a diameter from 0.3 to 0.6 mm and said withdrawing tube has an inside diameter from 3 to 6 millimeters

12. The assembly as claimed in claim 11 wherein said withdrawing tube has a length of 16 mm with axial inwardly protruding fins that are 0.8 millimeter thick.

13. The assembly as claimed in claim 5, for applying a sample of scent onto a person's body, wherein said bottle contains a sample of scent for application through said lid across said capillary migration canals pierced therethrough onto a person's body with its skin constituting said wetable surface, said migration canals having a diameter such that they allow the liquid to pass when but only when said wetable material is brought into contact with the outside face of said lid, and wherein said withdrawal tube is constructed in terms of its diameter and its length so as to withdraw from the bottle a determined dose of said liquid and retain it against gravity whatever the position of the bottle may be.

14. The assembly of claim 2, wherein said holes through said lid wall are able to act to release the liquid product by capillary migration from the withdrawing tube or as an air intake toward the reservoir of the bottle.

15. The assembly of claim 2, wherein said removable cap is covered on the interior surface of its radial terminal wall with a layer of material that is absorbent for the liquid possibly remaining on the outside of said lid after the applicator device has been in use, but unable to absorb the liquid inside the migration canals and the withdrawal tube.

16. The assembly as claimed in claim 6, wherein the withdrawal tube is provided in said insert part of said applicator device as a cylinder partition extending from the said lid part and the insert body forms a sleeve that surrounds the tube at some distance so that an annular space is formed between them.

17. The assembly as claimed in claim 16, wherein said sleeve is provided with external fins that ensure close fitting of said insert part inside the bottle neck by forcing it in.

18. An assembly for dispensing a liquid onto a wetable surface comprising a reservoir bottle for containing said liquid and applicator device having a lid part adapted to close the opening of said bottle and an integral insert part adapted for sealing connection with a neck of said bottle around said opening, a withdrawal tube formed in said insert part, that penetrates axially into said neck and is constructed so as to retain a determined dose of liquid product withdrawn from said bottle against the action of gravity through a capillary effect, a plurality of holes pierced through a terminal radial wall of said lid part that are constructed as migration canals for the capillary migration of said liquid product to a wetable surface brought into contact with said lid wall outside said bottle, a downstream end of said capillary migration canals opening to the outside of said lid and an upstream end of each one of said migration canals opening in said withdrawal tube, and a removable cap fitting over said lid part of the applicator device that comprises means for then closing off said migration canals and absorbing any trace of liquid remaining on the lid surface after the applicator device has been in use, while not sucking any remaining liquid out of the bottle or withdrawal tube through said migration canals.

19. An assembly for dispensing a liquid onto a wetable surface comprising a reservoir bottle for containing said liquid and applicator device having a lid part adapted to close the opening of said bottle and an integral insert part adapted for sealing connection with a neck of said bottle around said opening, a withdrawal tube formed in said insert part, that penetrates axially into said neck and is constructed so as to retain a determined dose of liquid product withdrawn from said bottle against the action of gravity through a capillary effect, a plurality of holes pierced through a terminal radial wall of said lid part that are constructed as migration canals for the capillary migration of said liquid product to a wetable surface brought into contact with said lid wall outside said bottle, a downstream end of said capillary migration canals opening to the outside of said lid and an upstream end of each one of said migration canals opening in said withdrawal tube, and a removable cap fitting over said lid part of the applicator device for sealing connection with an outer axial surface thereof, said cap further comprising internal means to close said migration canals and means to collect and retain any trace of liquid remaining on the lid surface after the applicator device has been in use, wherein said closing means for said migration canals are formed by extensions that extend in axial direction from a radial terminal wall of said cap and wherein said axial extensions are long enough to come close to each individual migration canal when said cap is in position to cover said lid part of said applicator device in sealing relationship with a peripheral outer surface thereof and long enough to provide empty spaces between them in which any trace of liquid remaining outside on the lid surface after use is collected.

20. The assembly as claimed in claim 19, wherein said migration canals are five in number, with one being located on the center axis of said insert part and the other four being on an annular ring around said center axis at right-angle intervals and wherein said axial extensions comprise a central axial extension for the one migration canal that is located on the center axis while for the other four migration canals there is provided an annular ring extension that ensures rigidity and correct placement with respect to the canals.

21. The assembly as claimed in claim 19, wherein the withdrawal tube is provided in said insert part of said applicator device as a cylinder partition extending from said lid part and wherein the insert body forms a sleeve that surrounds the tube at some distance so that an annular space is formed between said partition and said sleeve.
